(19) United States
(12) Patent Application Publication
(10) Pub. No.: US 2018/0215374 A1
(43) Pub. Date: Aug. 2, 2018

(54) SELF-PARKING VEHICLE

(71) Applicant: Ford Global Technologies, LLC, Dearborn, MI (US)

(72) Inventors: Seok Lee, Canton, MI (US); Leonard Eber Carrier, Dearborn, MI (US); Daniel A. Gabor, Canton, MI (US)

(73) Assignee: Ford Global Technologies, LLC, Dearborn, MI (US)

(21) Appl. No.: 15/417,502

(22) Filed: Jan. 27, 2017

(51) Int. Cl. B60W 30/06; G08G 1/14; B60L 11/18; G05D 1/00; B62D 15/02; G05D 1/12

(52) U.S. Cl. CPC B60W 30/06; G08G 1/143; G05D 1/12; G05D 1/0088; B62D 15/0285; B60L 11/1809

(57) ABSTRACT

A computer is programmed to, upon determining that a user has departed a vehicle, identify available parking spaces based at least in part on one of stored parking restrictions and vehicle sensor data. The computer is programmed to select one of the parking spaces based at least in part on a distance to a respective parking space and an environmental condition. The computer navigates the vehicle to park at the selected parking space.

### BACKGROUND

Autonomous or self-driving vehicles may be completely or partly operated by a vehicle computer. Such vehicles need to make decisions relating to navigation, including routes to be traversed, as well as operation along a route, e.g., maintaining a speed, heading, etc. Navigation in urban environments can be particularly problematic, e.g., due to a density of moving and/or parked vehicles on urban roadways. Moreover, when a vehicle is not being navigated, e.g., is not moving along an urban roadway, problems can arise because current mechanisms for vehicles to identify, navigate to, and park in, urban parking places are lacking.

### BRIEF DESCRIPTION OF THE DRAWINGS

FIG. 1 is a block diagram of an exemplary vehicle system.

FIG. 2 is a diagram showing vehicles and parking spaces in an exemplary urban area.

FIG. 3 is a flowchart of an exemplary process to park a vehicle.

### DETAILED DESCRIPTION

### Introduction

Referring to the Figures, a host vehicle 100 computer 110 is programmed to, upon determining that a user has departed the vehicle 100, identify available parking spaces 205b, 205c, 205d based at least in part on one of stored parking restrictions and vehicle sensor data. The computer 110 is further programmed to select one of the parking spaces based at least in part on a distance d₁, d₂, d₃ to a respective parking space 205b, 205c, 205d and an environmental condition. The computer 110 is programmed to then navigate the vehicle 100 to park at the selected parking space 205.

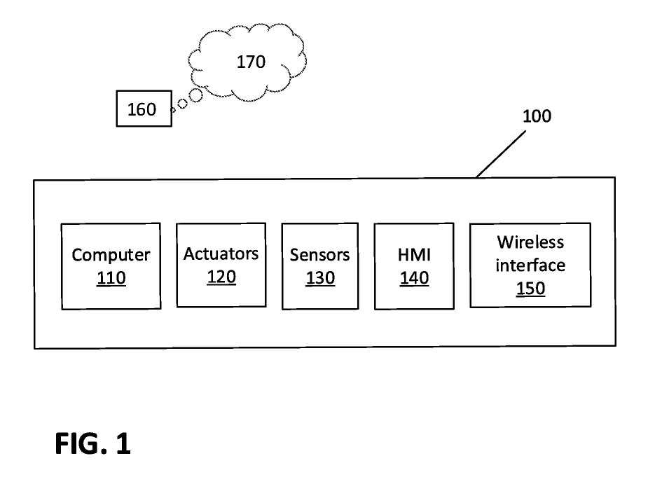

FIG. 1 is a block diagram of a vehicle 100. A host vehicle 100 may include a computer 110, actuator(s) 120, sensor(s) 130, a human machine interface (HMI) 140, and a wireless interface 150, each of which are discussed in more detail below.

### Exemplary System Elements

FIG. 1 illustrates a vehicle 100. The vehicle 100 may be powered in a variety of known ways, e.g., with an electric motor and/or internal combustion engine. The vehicle 100 may be a land vehicle such as a car, truck, etc. A vehicle 100 may include a computer 110, actuator(s) 120, sensor(s) 130, and an HMI 140.

The computer 110 includes a processor and a memory such as are known. The memory includes one or more forms of computer-readable media, and stores instructions executable by the computer 110 for performing various operations, including as disclosed herein.

The computer 110 may operate the vehicle 100 in an autonomous mode, a semi-autonomous mode, or a non-autonomous mode. For purposes of this disclosure, an autonomous mode is defined as one in which each of vehicle 100 propulsion, braking, and steering are controlled by the computer 110; in a semi-autonomous mode the computer 110 controls one or two of vehicles 100 propulsion, braking, and steering; in a non-autonomous mode, an operator controls the vehicle 100 propulsion, braking, and steering.

The computer 110 may include programming to operate one or more of vehicle 100 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via a vehicle 100 communications bus as described further below, more than one processor, e.g., controllers or the like included in the vehicle for monitoring and/or controlling various vehicle controllers, e.g., a powertrain controller, a brake controller, a steering controller, etc. The computer 110 is generally arranged for communications on a vehicle communication network that can include a bus in the vehicle such as a controller area network (CAN) or the like, and/or other wired and/or wireless mechanisms.

Via the vehicle 100 network, the computer 110 may transmit messages to various devices in the vehicle and/or receive messages from the various devices, e.g., an actuator 120, an HMI 140, etc. Alternatively or additionally, in cases where the computer 110 actually comprises multiple devices, the vehicle 100 communication network may be used for communications between devices represented as the computer 110 in this disclosure. As discussed further below, various electronic controllers and/or sensors 130 may provide data to the computer 110 via the vehicle communication network.

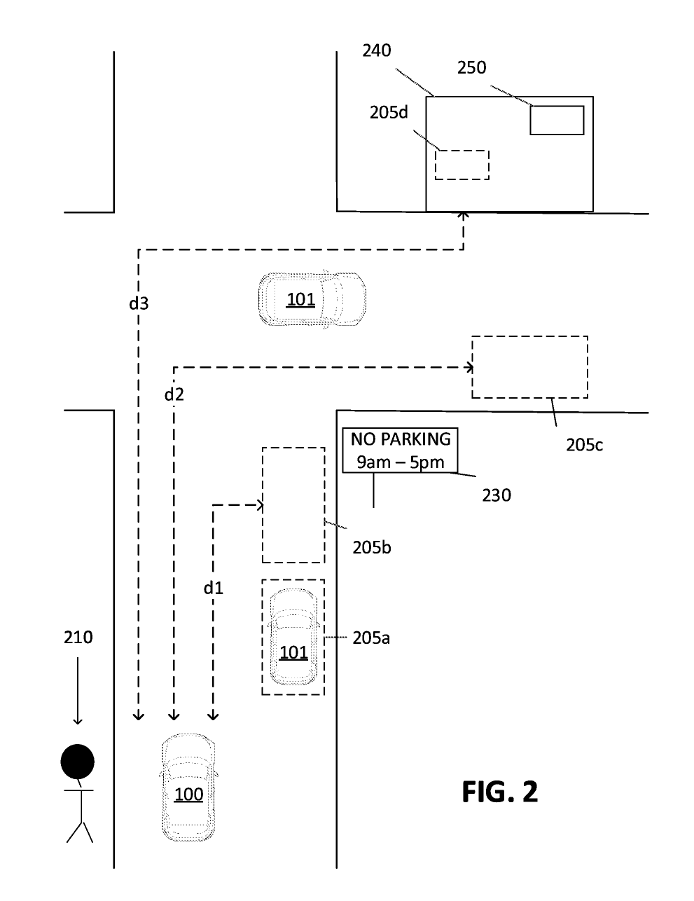

The computer 110 may be configured for communicating through a wireless interface 150 with other vehicles 101 (see FIG. 2), e.g., via a vehicle-to-vehicle and/or vehicle-to-infrastructure communication network 170. Additionally or alternatively, the computer 110 may be configured for communicating through the wireless interface 150 with a remote computer 160. The wireless communication network 170 represents one or more mechanisms by which the computers 110 of vehicles 100 may communicate with other vehicles 101, and may be one or more of wireless communication mechanisms, including any desired combination of wireless (e.g., cellular, wireless, satellite, microwave and radio frequency) communication mechanisms and any desired network topology (or topologies when multiple communication mechanisms are utilized). Exemplary V-to-V communication networks include cellular, Bluetooth, IEEE 802.11, dedicated short range communications (DSRC), and/or wide area networks (WAN), including the Internet, providing data communication services. The wireless interface 150 may include known electronic circuitry such as a radio frequency transmitter, a radio frequency receiver, and an amplifier circuit to boost an outgoing and incoming radio-frequency signal.

The remote computer 160, e.g., a cloud computer, is typically a computer with a processor and a memory such as are known. Further, the memory includes one or more forms of computer-readable media, and stores instructions executable by the processor for performing various operations, including as disclosed herein.

The vehicle 100 actuators 120 are implemented via circuits, chips, or other electronic and/or mechanical components that can actuate various vehicle subsystems in accordance with appropriate control signals, as is known. The actuators 120 may be used to control vehicle 100 systems such as braking, acceleration, and/or steering of the vehicles 100.

Vehicle 100 sensors 130 may include a variety of devices known to provide data via the vehicle network. For example, the sensors 130 may include one or more camera, radar, and/or LIDAR sensors 130 disposed in and/or on the vehicle 100 providing data encompassing at least some of the vehicle 100 exterior. The data may be received by the computer 110 through a suitable interface such as in known. A sensor 130 disposed, e.g., on a top of the vehicle 100, may provide object data, i.e., data including relative locations, sizes, and/or shapes, etc., of objects such as other vehicles 101 surrounding the vehicle 100. A vehicle 100 computer 110 may receive the object data and operate the vehicle in an autonomous and/or semi-autonomous mode based at least in part on the received object data. A vehicle 100 occupancy sensor 130, e.g., an occupancy sensor disposed in a vehicle 100 seat, etc., may provide data including whether a vehicle 100 user has departed the vehicle 100. Additionally or alternatively, the computer 110 may determine whether vehicle 100 user(s) has/have left the vehicle 100 based on data received from one or more camera sensors 130 with a field of view including a vehicle 100 interior.

The computer 110 may be programmed to determine, e.g., parking spaces 205a, 205b, based on data received from vehicle 100 sensors 130 (see FIG. 2). As one example, the computer 110 may be programmed to identify parking spaces 205a, 205b based on image data received from a camera sensor 130 including road markings associated with the parking spaces 205a, 205b. The computer 110 may be programmed to determine a parking restriction associated with one or more parking spaces 205a, 205b based on image data, e.g., including a parking restriction sign 230, received from a vehicle 100 camera sensor 130. A camera sensor 130, rain sensor 130, temperature sensor 130, etc. may provide data including environmental condition, e.g., rain, snow, wind, hail, etc.

The HMI 140 may be configured to receive user input, e.g., during operation of the vehicle 100. For example, a user may select a mode of operation, e.g., an autonomous mode, by inputting a requested mode of operation via an HMI 140. As one example, an HMI 140 may include touchscreens, buttons, knobs, keypads, microphone, and so on for receiving information from a user. Moreover, an HMI 140 may include various interfaces such a Ford SYNC® computing interface, a smart phone, etc., for receiving information from a user and/or output information to the user.

With reference to FIG. 2, a first vehicle 100 computer 110 may be programmed to determine whether a user 210 has departed the first vehicle 100, e.g., based on data received from an occupancy sensor 130. Additionally or alternatively, the computer 110 may determine whether all users 210 have departed, e.g., when more than one users 210 have been detected in the first vehicle 100, e.g., based on camera sensor 130 image data and/or occupancy sensor 130 data. Upon determining that the user(s) 210 has/have departed the vehicle 100, the computer 110 may identify available parking spaces such as spaces 205b, 205c, 205d based at least in part on one of stored parking restrictions, e.g., parking restriction sign 230, and vehicle 100 sensor 130 data.

The computer 110 may detect the parking space 205d located in a parking structure 240, based on, e.g., data received from a parking structure 240 computer 250. The received data from the computer 250 may include number, size, cost, etc. of any available parking space 205d inside a parking structure 240. Further, the computer 110 may be programmed to select one of the available parking spaces 205b, 205c, 205d based at least in part on a distance d₁, d₂, d₃ to a respective parking space 205b, 205c, 205d and an environmental condition. The computer 110 then navigates the vehicle 100 to park at the selected parking space by actuating vehicle 100 actuators 120, e.g., a propulsion, braking, and/or steering actuator 120.

The computer 110 may be programmed to detect one or more parked vehicles, e.g., a second vehicle 101 in the parking space 205a, and identify the available parking spaces, e.g., the space 205b, based at least in part on the detected one or more parked vehicles. For example, the computer 110 may be programmed to detect a second vehicle 101 based on images data received from a camera sensor 130, etc. Upon the detection of the second vehicle 101, the computer 110 may be programmed to receive object data including size, location, speed, etc. of the detected second vehicle 101. Additionally or alternatively, the computer 110 may be programmed to receive object data, as described above, from the remote computer 160 via the wireless communication network 170 and/or a second vehicle 101 computer 110.

Further, the computer 110 may be programmed to detect parking spaces 205a, 205b based on image data received from a vehicle 100 camera sensor 130. As one example, the computer 110 may detect parking spaces 205a, 205b based on marking(s) on a road surface. Additionally or alternatively, the computer 110 may detect parking spaces based on determining a size of a gap between parked vehicles 101 and determining whether the gap has sufficient size to park the vehicle 100, e.g., based on vehicle 100 size. Further, the computer 110 may determine which one of the detected parking spaces 205a, 205b are available based at least on the detected second vehicles 101. In example shown in FIG. 2, the computer 110 may determine that the parking space 205a is occupied by a detected second vehicle 101 based on the received object data. Additionally, the computer 110 may be further programmed to determine, e.g., based on sensor 130 data, whether a parking space is occupied by any other types of vehicle, e.g., a motorcycle, bike, etc. and/or an object such as a traffic cone.

The computer 110 may be programmed to receive a list of available parking spaces from a second vehicle 101 and identify the parking space based at least in part on the received list. For example, a second vehicle 101 computer may be programmed to detect the parking space 205c, determine that the parking space 205c is available, e.g., based on an absence of a second vehicle 101 occupying the parking space 205c, and send data including the location coordinates, size, etc. of the available parking space 205c via the wireless communication network 170 to the first vehicle 100. Thus, advantageously, the first vehicle 100 computer 110 may detect the parking space 205c that is outside a field of a view of the vehicle 100 sensors 130. Additionally or alternatively, the vehicle 100 computer 110 may determine whether a parking space outside a field of view of the vehicle 100 sensors 130 is available based on map data including location coordinates, size, etc. of parking spaces and location data received from a second vehicle 101. Additionally or alternatively, the vehicle 100 computer 110 may determine whether a parking space is available based at least in part on data received and/or stored from a remote computer 160. Thus, the computer 110 may receive location coordinates of parked second vehicles 101 and determine whether any of the parking spaces is available based on the received location coordinates of the parked second vehicles 101.

As described above, the computer 110 may identify available parking space(s) based at least in part on parking restriction(s). Parking restrictions in the context of this disclosure include restrictions imposed on parking a vehicle 100 based on posted traffic signs, restrictions not posted but applicable based on traffic laws, police instruction, etc., and/or restrictions based on predetermined parameters.

The computer 110 may be programmed to determine whether the parking space 205b is available based on the traffic sign 230 and a current time. For example, the computer 110 may be programmed to determine that the parking space 205b is unavailable, even when the parking space 205b is unoccupied, if the current time is in a time interval of 9 am-5 pm indicated by the sign 230 as a “no-parking time.” Additionally or alternatively, the computer 110 may be programmed to determine whether the parking space 205b is available based on stored data, e.g., parking restriction data, and a current time.

The computer 110 may determine a parking space adjacent a fire hydrant is unavailable based on, e.g., a traffic law prohibiting a vehicle parking within 5 meters of a fire hydrant. The vehicle 100 computer 110 may detect based on data received from a camera sensor 130, e.g., a red marking, indicating a parking restriction because of a fire hydrant. Additionally or alternatively, the computer 110 may be programmed to detect a fire hydrant based on known image processing techniques and determine an area within a certain distance, e.g. 5 meters, from the detected fire hydrant as unavailable for parking.

The vehicle 100 computer 110 may be programmed to receive data from a remote computer 160 including, e.g., a restriction of parking on a side of a street section because of an event. The vehicle 100 computer 110 may further identify parking restrictions based on vehicle 100 properties such as one or more vehicle dimensions, i.e., a size of the vehicle 100. For example, the computer 110 of a truck vehicle 100 may identify a parking space unavailable if the parking space is only suitable for a compact vehicle 100, e.g., based on a posted sign “COMPACT VEHICLES ONLY” and/or a detection of a parking space size based on vehicle 100 sensor 130 data.

The vehicle 100 computer 110 may be programmed to identify an available parking space based on predetermined user parameter. The predetermined user parameters may include restrictions such as “no parking on a side street,” “no parking behind a truck,” “park only at parking spaces with street light during night hours,” etc. The computer 110 may be programmed to determine that a parking space is available, if the respective parking space fulfils conditions based on the predetermined user parameters, e.g., “no parking on a side street.”

The vehicle 100 computer 110 may be programmed to select, e.g., a parking space 205b, based at least in part on a cost of parking at the parking space. For example, the computer 110 may determine the cost of parking at the available parking spaces 205b, 205c, 205d and select the parking space 205b based on the determined cost of parking, e.g., because the cost of parking at 205b is a minimum among the costs of parking in any of the available parking spaces 205b, 205c, 205d. In order to determine the cost of parking, the vehicle 100 computer 110 may be programmed to receive parking fee data, e.g., based on posted hourly rates on a sign, data received from a remote computer 160, etc., and a user 210 plan including, e.g., an start time and end time of parking.

The vehicle 100 computer 110 may be further programmed to move the vehicle 100 away from the selected parking space, e.g., to another parking space, upon determining that a remaining time before a parking restriction applies to the selected parking space is less than a predetermined time threshold, e.g., 5 minutes. For example, the vehicle 100 computer 110 may move the vehicle 100 away from the parking space 205b at 8:55 am because of the “NO PARKING” restriction from 9 am to 5 pm associated with the parking space 205b.

The computer 110 may be programmed to prevent a movement of the vehicle 100 to a second parking space upon determining that the vehicle 100 is being recharged, e.g., based on data received from a vehicle 100 sensor 130. Additionally or alternatively, the computer 110 may be programmed to prevent a movement of the vehicle 100 to a second parking space upon determining that the vehicle 100 is physically blocked and/or a fault event, e.g., a mechanical issue, has occurred in the vehicle 100. For example, the vehicle 100 may be blocked when there is insufficient distance between the vehicle 100 and adjacently parked second vehicles 101 to move out of the parking space.

The vehicle 100 computer 110 may be programmed to determine a score for a parking space, identify a second parking space upon determining that the score of the parking space is below a score threshold, and navigate the vehicle to the second parking space. A score of a parking space may be expressed in a numerical format, e.g., a number from 1 to 10, while 1 indicates a least favorable and 10 indicates a highly favorable parking space. For example, the vehicle 100 computer 110 may navigate the vehicle 100 away from the parking space 205b upon determining that a score of the parking space 205b is below, e.g., a score threshold of 4.

The vehicle 100 computer 110 may be programmed to determine a score for a parking space according to at least one of the environmental condition and a risk of vehicle damage. The score may be defined based on a mathematical function based on various inputs, e.g., S=w₁ E+w₂ R+w₃ C+w₄ D. S, E, R, C, and D represent, respectively, a score, environmental condition, risk of damage, cost level (fees), and proximity (all of which can be provided on a normalized scale, e.g., 1 to 10) associated with a specified parking space. The parameters w₁, w₂, w₃, and w₄ represent weight factors for each of the inputs E, R, C and D. In other words, by increasing or reducing the factors w₁, w₂, w₃, and w₄, an effect of each input E, R, C and D on the calculated score (S) is increased or reduced respectively.

The computer 110 may determine an environmental condition E associated with a parking space based on current environmental data received from, e.g., a rain sensor 130, a temperature sensor 130, a remote computer 160, etc. and/or weather forecast data received from a remote computer 160. The environmental condition E may be numerically stated with a number between 1 (very inclement weather) and 10 (very good weather).

The computer 110 may determine a risk R for a parking space based on a crime index associated with an area including the respective parking space. For example, a risk R may be stated numerically with a number between 1 (very high risk area) and 10 (very safe area). The computer 110 may be programmed to determine the risk R of a vehicle 100 damage based on data received from, e.g., a vehicle 100 vibration sensor 130, pressure sensor 130, etc. For example, the computer 110 may associate a higher risk to a parking space based on increased level of pressure and/or vibration applied to the vehicle 100, e.g., when an intruder forcibly tries to break into the vehicle 100. Additionally or alternatively, the computer 110 may determine a risk R of a parking space based on data, e.g., crime map, received from the remote computer 160.

The computer 110 may determine a cost level C for a parking space based on an hourly rate, duration of parking, etc. associated with the respective parking space. The cost level C may be numerically stated with a number between 1 (very expensive) and 10 (free or very inexpensive). In one example, the computer 110 may be programmed to move the vehicle 100 from a first parking space 205b, to a second parking space 205d, upon determining a change of cost level C for the parking space 205d. The cost of parking space 205d at the parking structure 240 may change after, e.g., 5 pm, so as to be lower than the cost of parking at the parking space 205b. Thus, the computer 110 may be programmed to move the vehicle 100 from to the parking space 205d.

The computer 110 may determine a proximity D associated with a parking space based on a navigation route determined using known navigation techniques. For example, the computer 110 may determine a proximity D associated with the parking spaces for the parking spaces 205b, 205c, and 205d based on the distances d₁, d₂, and d₃. A lower D may indicate a longer distance, e.g., a D value associated with the parking space 205d may be the lowest among the D values for the parking spaces 205b, 205c, and 205d. D may be defined numerically with a number between 1 (too far) and 10 (very near).

The computer 110 may be programmed to receive a departure time and a user 210 location, and navigate the vehicle 100 to the user 210 location according to the departure time and the user 210 location. Additionally or alternatively, the computer 110 may be programmed to navigate the vehicle 100 to the user 210 location, upon receiving a pickup request, e.g., from a user 210 mobile device such as a smart phone. The computer 110 may navigate to a pickup location based on, e.g., location coordinates received from the user 210 mobile device.

### Processing

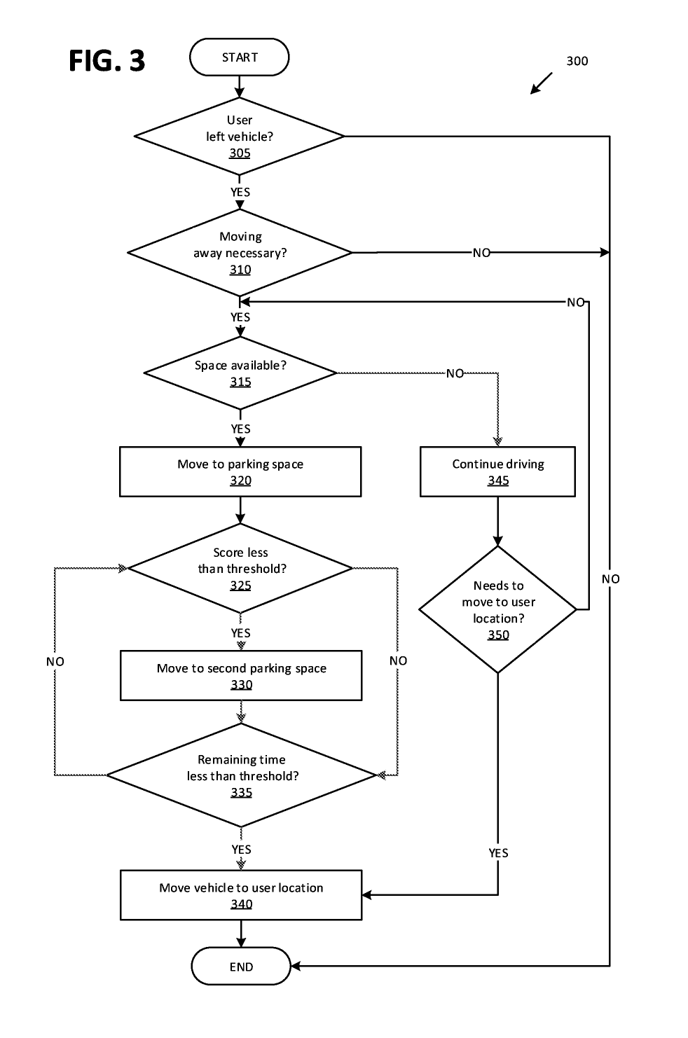

FIG. 3 is a flowchart of an exemplary process 300 to park a vehicle 100. In one example, the vehicle 100 computer 110 can be programmed to execute and/or to instruct actuators and otherwise to make determinations to execute blocks of the process 300.

The process 300 begins in a decision block 305, in which the computer 110 determines whether user(s) 210 has/have departed the vehicle 100, e.g., based on data received from a vehicle 100 occupancy sensor 130, camera sensor 130, etc. Additionally or alternatively, the computer 110 may be programmed to determine whether all users 210 have departed the vehicle 100. If the computer 110 determines that the user(s) 210 have departed the vehicle 100, then the process 300 proceeds to a decision block 310; otherwise the process 300 ends, or, alternatively, returns to the decision block 305.

In the decision block 310, the computer 110 determines whether the vehicle 100 should move away from a current vehicle 100 location. The computer 110 may determine that the vehicle 100 should move away based on a parking command received from a vehicle 100 user via a vehicle 100 HMI 140, a user 210 mobile device, etc. The parking command may further include a departure time and location. A departure location may be a location at which the user(s) 210 left the vehicle 100 or a different location included in the parking command. Alternatively, the computer 110 may be programmed to maintain current vehicle 100 location, e.g., if no data is received that includes a request to move the vehicle away. If the computer 110 determines that the vehicle 100 should move away from the current location, then the process 300 proceeds to a decision block 315; otherwise the process 300 ends, or, alternatively, returns to the decision block 305.

In the decision block 315, the computer 110 determines whether a parking space is available for the vehicle 100. For example, the computer 110 may determine that no parking is available, when, e.g., no parking spaces is available within a predetermined distance from the current vehicle 100 location, available parking spaces have a score less than a score threshold, etc. If the computer 110 determines that parking space(s) is/are available for the vehicle 100, then the process 300 proceeds to a block 320; otherwise the process 300 proceeds to a block 345.

In the block 320, the computer 110 moves the vehicle 100 to a parking space. The computer 110 may determine one or more available parking spaces 205b, 205c, 205d, determine scores associated with the available parking spaces, and select, e.g., a parking space 205b based on the determined scores of the available parking spaces. The computer 110 may then determine navigation instructions to the selected parking space 205b using known route determination techniques. Further, the computer 110 may then move the vehicle 100 based on the determined navigation instructions to the selected parking space 205b, e.g., by actuating vehicle 100 propulsion, steering, and/or braking actuators 120 to travel along a determined route.

Next, in a decision block 325, the computer 110 determines whether a score of a current parking space, e.g., the parking space 205b, is less than a score threshold. The computer 110 may be programmed to determine the score of the current parking space based on an environmental condition, a risk, a cost level, etc. associated with the current parking space. For example, the computer 110 may determine the score, e.g., a number between 1 and 10, based on a score function, a described above. The computer 110 then determines whether the determined score of the current parking space is less than a predetermined threshold, e.g., 4. A score less than the predetermined threshold may indicate an unfavorable parking space. If the computer 110 determines that the determined score is less than the predetermined threshold, then the process 300 proceeds to a block 330; otherwise the process 300 proceeds to a decision block 335.

In the block 330, the computer 110 moves the vehicle 100 to a second parking space. In one example, the computer 110 determines one or more available parking spaces 205c, 205d, and selects one of the available parking spaces, e.g. based on comparing scores of the available parking spaces 205c, 205d. For example, the parking space 205d inside the parking structure 240 may have a lower risk, better environmental condition (e.g., no rain, hail, etc.), but more expensive than the parking space 205c. Depending on the inputs E, R, C and D, and the weight factors w₁, w₂, w₃, and w₄, a score of the parking space 205d may be greater than a score of the parking space 205c. Thus, the computer 110 may select the parking space 205d, determine navigation instructions to the parking space 205d, and move the vehicle 100 based on the determined navigation instructions to the parking space 205d.

Next, in a decision block 335, the computer 110 determines whether a remaining time to the departure time (i.e., the time to pick up the user 210 in a predetermined location) is less than a predetermined time threshold. The time threshold may be a constant predetermined amount, e.g. 5 minutes, or may be a variable number depending on a travel time from the vehicle 100 parking space to the user 210 pick-up location. The computer 110 may be programmed to determine a travel time from the vehicle 100 parking space to the predetermined pick-up location based on map data and current traffic conditions. If the computer 110 determines that the remaining time to the departure time is less than a predetermined time threshold, then the process 300 proceeds to a block 340; otherwise the process 300 returns to the decision block 325.

In the block 340, the computer 110 actuates the vehicle 100 actuators 120 to move the vehicle 100 to the user 210 location and/or a predetermined pick-up location. If the user 210 location and/or the predetermined pick-up location is inaccessible by the vehicle 100, e.g., in a pedestrian zone, inside a shopping mall, etc., the computer 110 may be further programmed to determine a nearest location to the pick-up location which is accessible by the vehicle 100 and navigate the vehicle 100 to the determined nearest location. Following the block 340, the process 300 ends, or alternatively returns to the decision block 305.

In the block 345, the computer 110 is programmed to actuate the vehicle 100 actuators 120 to continue driving. The block 345, is reached when the computer 110 was unable to find and/or select a parking space for the vehicle 100. The computer 110 may be programmed to determine a route, e.g., based on a possibility of finding a parking space, and navigate the vehicle 100 based on the determined route. For example, the computer 110 may determine one or more parking spaces which may be available soon, e.g., compared to all vehicles 101 parked in an area within a distance threshold from the vehicle 100, e.g., based on data received from the remote computer 160 including expected end of paid parking duration of vehicle(s) 101. The computer 110 may be further programmed to determine a route to drive around an area where the parking spaces that may be soon available are located.

Next, in a decision block 350, the computer 110 determines whether to navigate the vehicle 100 to the pickup location. The computer 110 may determine a time to travel to the pick-up location based on the predetermined pick-up time and a current location of the vehicle 100. For example, the computer 110 may determine whether to navigate the vehicle 100 to the pick-up location, upon determining that a remaining time to pick-up is less than the determined driving time to the pick-up location. If the computer 110 determines that the vehicle 100 should navigate to the pick-up location, then the process 300 proceeds to the block 340; otherwise the process 300 returns the decision block 315.

Computing devices as discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH, an EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. A computer, programmed to:
upon determining that a user has departed a vehicle, identify available parking spaces based at least in part on one of stored parking restrictions and vehicle sensor data;
select one of the parking spaces based at least in part on a distance to a respective parking space and an environmental condition; and
navigate the vehicle to park at the selected parking space.

2. The computer of claim 1, further programmed to detect one or more parked vehicles, and identify the available parking spaces based at least in part on the detected one or more parked vehicles.

3. The computer of claim 1, wherein the stored parking restrictions include one or more predetermined user parameters.

4. The computer of claim 1, further programmed to select the parking space based at least in part on a cost of parking at the parking space.

5. The computer of claim 1, further programmed to move the vehicle away from the selected parking space upon determining that a remaining time before a parking restriction applies to the selected parking space is less than a predetermined time threshold.

6. The computer of claim 1, further programmed to:
determine a score for the parking space;
identify a second parking space upon determining that the score of the parking space is below a threshold; and
navigate the vehicle to the second parking space.

7. The computer of claim 6, further programmed to determine the score for the parking space according to at least one of the environmental condition and a risk of vehicle damage.

8. The computer of claim 7, further programmed to determine the risk of vehicle damage based on data received from at least one of a vehicle vibration sensor and a vehicle pressure sensor.

9. The computer of claim 1, further programmed to:
receive a departure time and a user location; and
navigate the vehicle to the user location according to the departure time and the user location.

10. The computer of claim 1, further programmed to receive a list of available parking spaces from a second vehicle and identify the parking space based at least in part on the received list.

11. The computer of claim 1, further programmed to prevent a movement of the vehicle to a second parking space upon determining that the vehicle is being recharged.

12. A method, comprising:
upon determining that a user has departed a vehicle, identifying available parking spaces based at least in part on one of stored parking restrictions and vehicle sensor data;
selecting one of the parking spaces based at least in part on a distance to a respective parking space and an environmental condition; and
navigating the vehicle to park at the selected parking space.

13. The method of claim 12, further comprising detecting one or more parked vehicles, and identifying the available parking spaces based at least in part on the detected one or more parked vehicles.

14. The method of claim 12, wherein selecting the parking space is based at least in part on a cost of parking at the parking space.

15. The method of claim 12, further comprising moving the vehicle away from the selected parking space upon determining that a remaining time before a parking restriction applies to the selected parking space is less than a predetermined time threshold.

16. The method of claim 12, further comprising:
determining a score for the parking space;
identifying a second parking space upon determining that the score of the parking space is below a threshold; and
navigating the vehicle to the second parking space.

17. The method of claim 16, wherein determining the score for the parking space is according to at least one of the environmental condition and a risk of vehicle damage.

18. The method of claim 17, wherein determining the risk of vehicle damage is based on data received from at least one of a vehicle vibration sensor and a vehicle pressure sensor.

19. The method of claim 12, further comprising:
receiving a departure time and a user location; and
navigating the vehicle to the user location according to the departure time and the user location.

20. The method of claim 12, further comprising preventing a movement of the vehicle to a second parking space upon determining that the vehicle is being recharged.
